(19) United States
(12) Patent Application Publication
(10) Pub. No.: US 2024/0391003 A1
(43) Pub. Date: Nov. 28, 2024

(54) CIRCULAR SAW BLADE

(71) Applicant: KANEFUSA KABUSHIKI KAISHA, Niwa-gun, Aichi (JP)

(72) Inventors: Nobuhide YAMADA, Niwa-gun, Aichi-ken (JP); Yu YASUDA, Niwa-gun, Aichi-ken (JP); Fuminori OKABE, Niwa-gun, Aichi-ken (JP)

(73) Assignee: KANEFUSA KABUSHIKI KAISHA, Niwa-gun, Aichi-ken (JP)

(21) Appl. No.: 18/695,085

(22) PCT Filed: Aug. 23, 2022
(86) PCT No.: PCT/JP2022/031697

§ 371 Date: Mar. 25, 2024

(30) Foreign Application Priority Data
Oct. 4, 2021 (JP) 2021-163255

(51) Int. Cl. B23D 61/02

(52) U.S. Cl. CPC B23D 61/021

(57) ABSTRACT

A circular saw blade for metal cutting includes a disk-shaped base metal, a plurality of circumferentially-spaced gullets opening radially outward at an outer periphery of the base metal, a plurality of tip-receiving seats recessed at rear ends of the gullets relative to a rotational direction of the circular saw blade. The circular saw blade also includes cutting tips mounted to the base metal within the tip-receiving seats and protruding radially outward from the base metal. A thickness of each cutting tip is greater than a thickness of the base metal. Each cutting tip has a thin portion on a radially inner side of the cutting tip that is thinner than or equal to a thickness of the base metal. The thin portion is located within a thickness of each of the tip-receiving seats in the thickness direction.

### CROSS-REFERENCE TO RELATED APPLICATIONS

The present application is a 35 U.S.C. § 371 U.S. National Phase entry of, and claims priority to, PCT Application PCT/JP2022/031697 filed Aug. 23, 2022, which claims priority to Japanese Patent Application No. 2021-163255 filed Oct. 4, 2021, each of which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates to a disk-shaped circular saw blade. The circular saw blade may be used, for example, for cutting workpieces of various metals, and has a plurality of cutting tips attached to its outer periphery.

Conventional circular sawing machines are configured to cut, for example, various metal workpieces at high speed. Such circular sawing machines utilize a disk-shaped circular saw blade with a blade thickness such as 2 mm. Circular saw blades for cutting metal cut a workpiece by forming a groove in the workpiece of steel material or non-steel material such as aluminum. The circular saw blade has a disk-shaped base metal and a plurality of cutting tips attached at predetermined circumferential intervals along the outer periphery of the disk-shaped base metal. The cutting tips may be made of relatively hard cemented carbide or cermet, etc.

Conventionally, a circular saw blade for metal cutting includes cutting tips. Each cutting tip has a thickness that is thicker than the base metal and has a flat side profile. A joint of the cutting tip, which is joined to the base metal, protrudes from the base metal in the thickness direction. When cutting a workpiece, chips are generated by the cutting edges. The generated chips are received in gullets formed between circumferentially adjacent cutting tips. When the circular saw blade is rotated, chips collide against the joints of the cutting tips that protrude in the thickness direction. The cutting tips may be chipped, typically starting at the points where the chips collide with the joints. The cutting tips are particularly susceptible to chipping in the area close to the joint.

In conventional circular saw blades for metal cutting, for example, a chip breaker may be formed on a rake face of the cutting tip. The chip breaker is arc-shaped as viewed in the thickness direction of the cutting tip. Chips produced by the cutting edges are fed along the arc-shaped surface of the chip breaker and curled into a spring-like shape. Elastic forces of the spring-like shaped chips may facilitate discharge of the chips from the gullets of the circular saw blade.

Circular saw blades for metal cutting may be used, for example, for cutting pipes, tubes, or solid materials. When cutting tips of a circular saw blade cut a solid material, the volume of chips produced during one rotation of a single cutting tip is greater than when cutting a non-solid material such as a pipe or tube. The volume of the gullets of circular saw blade may be insufficient for the type or size of the workpiece, or the generated chips may be excessively compressed in the chip breaker. In such cases, chips may not be discharged from the gullets properly, resulting in chip clogging. Consequently, the applicable range of the circular saw blade is limited by the size of the workpiece and other cutting conditions.

As described above, cutting tips may become chipped due to collision by chips or chips may be clogged in circular saw blades for metal cutting. As a result, the cutting performance of the circular saw blade may deteriorate. As also described above, the applicable range of the circular saw blade is limited by the size of the workpiece and other cutting conditions. Accordingly, there is a need for a circular saw blade for metal cutting that can suppress the reduction in cutting performance due to the influence of chips, and that that can be applied to a wide range of workpieces.

### BRIEF SUMMARY

According to one feature of the present disclosure, a circular saw blade for cutting metal has a disk-shaped base metal, a plurality of gullets opening radially outward at an outer periphery of the base metal, and recessed tip-receiving seats positioned at rear ends of the gullets relative to a rotational direction of the circular saw blade. The circular saw blade has cutting tips mounted in the tip-receiving seats and protruding radially outward from the base metal. Each of the cutting tips has a cutting edge at an intersection of a rake face and a flank intersect. Each of the cutting tips has a thickness that is thicker than that of the base metal. Each of the cutting tips has a thin portion on a radially inner side that has a thickness of less than or equal to that of the base metal. The thin portion is located within a thickness of the tip-receiving seat in a thickness direction.

Side faces of the thin portion on the radially inner side of the cutting tip do not protrude in the thickness direction more than the base metal. Therefore, chips are prevented from colliding with a joint on the radially inner side of the cutting tip, and chipping of the cutting tip can be prevented. Further, clogging caused by chips may be prevented at the joints on the radially inner side of the cutting tip. Thus, it is possible to prevent the cutting tip from chipping due to the influence of the chips and to reduce cutting performance deterioration due to the clogging caused by chips.

In the cutting edge according to another feature of the present disclosure, a rake angle defined by the rake face and a radial line of the base metal is negative. Accordingly, a length in the rotational direction of the thin portion provided on the radially inner side of the cutting tip over which the cutting tip is secured may be greater than a length in the rotational direction of a radially outer area of the cutting tip over which the cutting tip is secured. Therefore, an area of the joint at the radially inner side of the cutting tip and the tip-receiving seat is relatively wide. This prevents the cutting tip from being removed from the tip-receiving seat, thereby preventing a deterioration in cutting performance.

According to another feature of the present disclosure, the cutting tip has an inner area positioned radially inward of a front end of the tip-receiving seat in the rotational direction. The thin portion occupies the entire inner area. Therefore, the protrusion in the thickness direction that chips easily contact can be reduced over the entire area of the joint of the thin portion of the cutting tip. As a result, chipping of the cutting tip and clogging near the front end of the joint of the cutting tip can be more reliably suppressed.

According to another feature of the present disclosure, the thin portion has a first face that extends radially inward from a front face of the cutting tip and rearward relative to the rotational direction. The thin portion has a second face that extends rearward relative to the rotational direction from the first face. The thin portion has a third face that extends radially outward from a rear end of the second face relative to the rotational direction. The cutting tip has a rake face on the front side relative to the rotational direction. An arc-shaped chip breaker is recessed into the radially inner side of the rake face rearwardly relative to the rotational direction.

The thin portion may be formed to have a convex shape radially inward by the first to third faces. This allows the cutting tip to be firmly attached to the tip-receiving seat. Further, the displacement of the cutting tip relative to the tip-receiving seat in the rotational direction may be prevented. A radial length of the radially outer area is ensured to be longer than the thin portion to increase a radius of curvature of the chip breaker. This prevents chips from clogging in the chip breaker. Thus, for example, it is possible to cut a solid material with a larger diameter than that of a solid material falling within the applicable range of conventional circular saw blades.

### BRIEF DESCRIPTION OF THE DRAWINGS

FIG. 1 is a side view of an embodiment of a circular saw blade in accordance with principles described herein.

FIG. 2 is an enlarged side view of the circular saw blade of FIG. 1 taken in section II of FIG. 1.

FIG. 3 is a front view of a cutting tip of the circular saw blade of FIG. 1 as viewed from a rake face side.

FIG. 4 is a top view of the cutting tip of FIG. 3 as viewed from the flank side.

### DETAILED DESCRIPTION

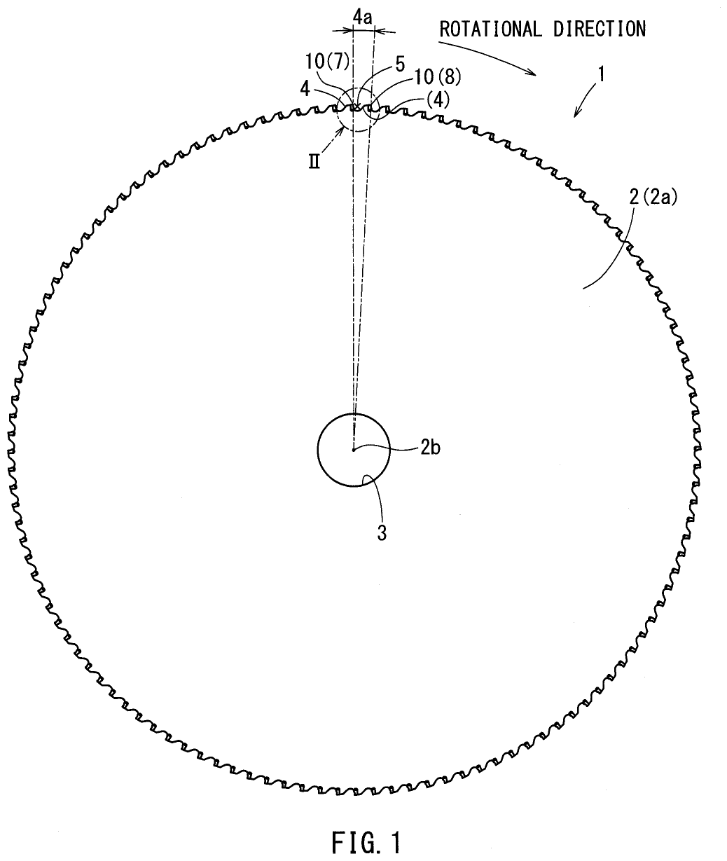

Preferred embodiments of the present disclosure will be described with reference to FIG. 1 to FIG. 4. The same reference numerals in the description refer to the same elements having the same function and will not be repeatedly described. In this embodiment, a circular saw blade 1 for metal processing will be described. As shown in FIG. 1, the circular saw blade 1 has a disk-shaped base metal 2 and a plurality of circumferentially-spaced cutting tips 10 mounted along an outer periphery of the base metal 2. By rotating the base metal 2 in the cutting rotational direction shown in FIG. 1, each cutting tip 10 forms a groove in the workpiece and ultimately cuts the workpiece. The workpiece may be, for example, steel materials such as carbon steel, general structural rolled steel, chrome molybdenum steel, stainless steel, cast iron, or nonferrous metals such as aluminum and aluminum alloys, copper and copper alloys. The workpiece may be, for example, tubular tube or pipe material, solid bar material, etc. The workpiece is cut to a predetermined length by the circular saw blade 1. The workpiece may be cut, for example, at room temperature.

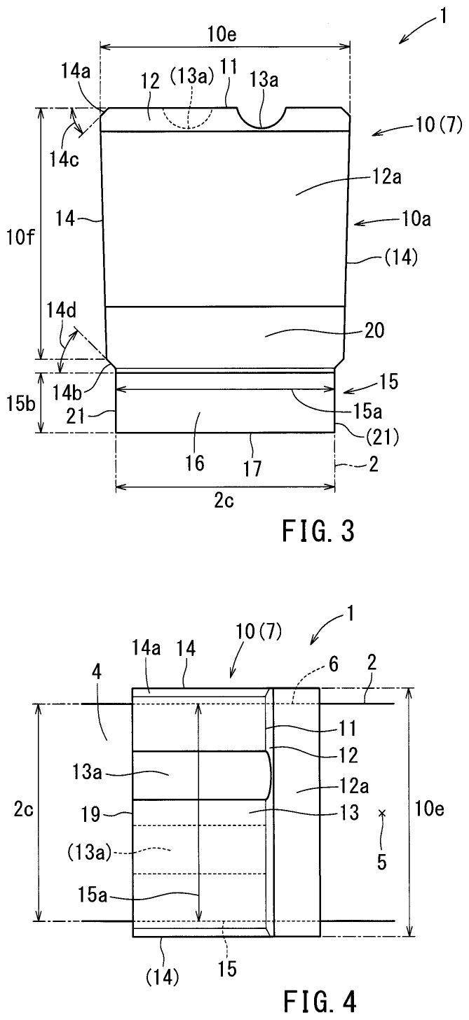

As shown in FIG. 1, the base metal 2 has a disk-shaped body 2a and a substantially circular mounting hole 3 that passes through a center of the body 2a in a thickness direction of the base metal 2. A rotation shaft of a circular sawing machine (not shown) is inserted into the mounting hole 3. The circular saw blade 1 rotates around a central axis 2b of the base metal 2 in the cutting rotational direction. A plurality of cutting tips 10 lined up around the outer periphery of the base metal 2 reach the workpiece in order in the rotational direction and cut the workpiece. An outer diameter of the circular saw blade 1 may preferably be 200 mm to 500 mm, for example 285 mm. The base metal 2 may be made of steel, for example. A thickness 2c of the base metal 2 (see FIG. 3) may be preferably 0.6 mm to 1.8 mm, for example 1.7 mm.

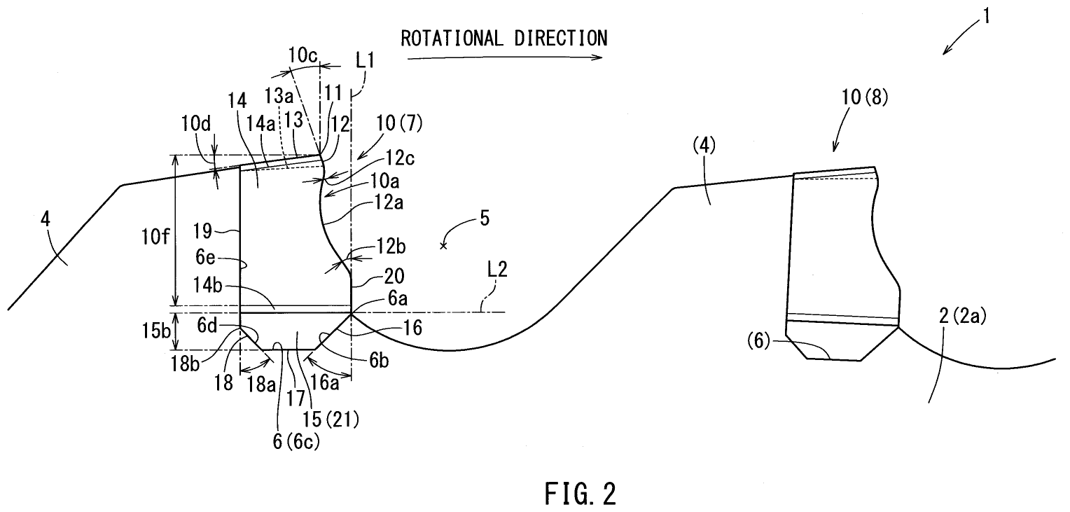

As shown in FIGS. 1 and 2, the base metal 2 has a plurality of circumferentially-spaced projections 4 protruding radially outward from the outer circumference of the body 2a. The protrusions 4 may be formed with an equally spaced pitch 4a in the circumferential direction of the body 2a. A gullet 5 is formed between each pair of circumferentially adjacent protrusions 4. A tip-receiving seat 6 is formed in each of the protrusion 4, and opens radially outward on the front side of the corresponding protrusion 4 relative to the rotational direction. A cutting tip 10 is seated in and attached to each tip-receiving seat 6. The circular saw blade 1 may preferably have from 40 to 200, for example, 120, of cutting tips 10.

As shown in FIGS. 2-4, the cutting tip 10 has a rectangular box-shaped tip body 10a and a rectangular box-shaped thin portion 15 provided radially inside the box-shaped tip body 10a. The box-shaped tip body 10a may have a height 10f of, for example, 2.0 mm in the radial direction. The box-shaped tip body 10a has a rake face 12 on a front side in the rotational direction and a flank 13 on a radially outer side. A cutting edge 11 is formed at an intersection of the rake face 12 and the flank 13. The cutting edge 11 extends in the thickness direction with a blade thickness 10e slightly greater than the thickness 2c of the base metal 2. The blade thickness 10e may be preferably 0.8 mm to 2.0 mm, for example 2.0 mm.

The cutting tips 10 are hard cutting tips made of, for example, cemented carbide or cermet. Cemented carbide may be obtained, for example, by mixing tungsten carbide with cobalt as a binder and sintering the mixture. Cermet may be obtained by mixing TiN, TiC, TiCN, etc. with cobalt as a binder and sintering the mixture. A surface of each cutting tip 10 may be coated to improve wear resistance.

As shown in FIGS. 2-4, a groove 13a is disposed along the flank 13 of the cutting tip 10 and extends in the circumferential direction. The groove 13a extends from the cutting edge 11 at a front end of the cutting tip 10 relative to the rotational direction of the flank 13 to a rear end of the cutting tip 10 relative to the rotational direction of the flank 13. The groove 13a has a substantially U-shape as viewed from the front end of the cutting tip 10 in the rotational direction of the circular saw blade 1. The groove 13a divides the cutting edge 11 into left and right sides (on opposite sides of the groove 13a). Therefore, chips cut from the workpiece are generally divided into left and right sides by the cutting edges 11 divided by the groove 13a. The groove 13a is positioned off-centered, either to the left or to the right from the center of the cutting tip 10 in the thickness direction by a predetermined distance. The cutting tips 10 include a first plurality or set of cutting tips 7 with the groove 13a positioned off-centered to the left from the center in the thickness direction and a second plurality or set of cutting tips 8 with the groove 13a off-centered to the right from the center in the thickness direction. The first cutting tips 7 and the second cutting tips 8 are arranged in an alternating fashion in the circumferential direction of the base metal 2.

As shown in FIG. 2, a clearance angle 10d measured between a circumferential tangent of the base metal 2 and the flank 13 may preferably be 5° to 15°, for example 10°. The rake angle 10c of the rake face 12 inclined relative to the radial direction of the base metal 2 may preferably be −30° to −5°, for example −20°.

As shown in FIGS. 2 and 3, a chip breaker 12a is formed on a radially inner portion of the rake face 12. The chip breaker 12 is recessed rearwardly relative to the rotational direction. The chip breaker 12a extends across the entire thickness direction of the tip body 10a. The chip breaker 12a has an arc-shape as being viewed in the thickness direction. The chips cut by the cutting edge 11 are fed to the side of the rake face 12 and curled in a spring-like shape by the chip breaker 12a. The chips curled by the chip breaker 12a are discharged from the gullets 5 or grooves formed in the workpiece via elastic forces.

As shown in FIG. 2, a radius of curvature of the chip breaker 12a is greater than or equal to 50% of the height 10f of the tip body 10a, for example, 1.2 mm. The tip body 10a has a front face 20 extending radially inward from a radially inner side of the chip breaker 12a to the base metal 2. An angle 12b at which the front face 20 intersects the radial inner side of the chip breaker 12a may be, for example, 35°. An angle 12c at which the rake face 12 intersects the radially outer side of the chip breaker 12a may be, for example, 30°.

As shown in FIG. 3, the tip body 10a has a side face 14 at each side of the flank 13 in the thickness direction. The side face 14 has an inclination angle of 0° to 2° with respect to the radial direction of the base metal 2, for example, 30° inward inclination angle (radial clearance angle). This slight inclination reduces a contact area between the side face 14 and the workpiece. Therefore, a cutting resistance acting on the side face 14 can be reduced. Furthermore, since the side face 14 is inclined such that it does not excessively protrude beyond a cut surface of the workpiece, a smooth finish of the cut surface can be ensured.

As shown in FIG. 2 to FIG. 4, an upper chamfer 14a is formed at the intersection of the flank 13 and each side face 14. The upper chamfer 14a is inclined with respect to the flank 13 as viewing from the front in the rotational direction, and may have a chamfer angle 14c of, for example, 45°. The upper chamfer 14a is defined by a planar surface with substantially the same width in the thickness direction moving in the rotational direction from a front of the flank 13 relative to the rotational direction to a rear of the flank 13 relative to the rotational direction. A width of the upper chamfer 14a in the thickness direction may be, for example, 0.05 mm to 0.1 mm.

As shown in FIG. 2, a thin portion 15 is provided at least radially inward of a radially inner area of the front face 20 of the cutting tip 10. More specifically, the cutting tip 10 has an inner area positioned radially inside an arc passing through the radially inner edge of the front face 20 at a constant radius from the center of the base metal 2. The inner area of the cutting tip 10 is occupied by the thin portion 15. The thin portion 15 is also located radially outward from the inner area. For example, the thin portion 15 may be located up to a tangent line L2 passing through the radially inner edge of the front face 20 and tangent to the arc disposed at a constant radius from the center of the base metal 2.

As shown in FIGS. 2-3, the thin portion 15 has a thickness 15a measured in the thickness direction less than or equal to the blade thickness 10e. The thickness 15a is less than or equal to the thickness 2c of the base metal 2, and may be, for example, 1.7 mm, which is the same as the thickness 2c. The side faces 21 of the thin portion 15 disposed within the tip-receiving seat 6 are flush with the side faces of the base metal 2 and do not extend outward at least to the left and right of the corresponding side faces of the base metal 2. Therefore, the thin portion 15 is seated in the tip-receiving seat 6 within a thickness of the tip-receiving seat 6 in the thickness direction.

As shown in FIG. 2, the thin portion 15 is substantially trapezoidal in shape as viewed in the thickness direction. The thin portion 15 has a first face 16, a second face 17, and a third face 18 that face radially inward and are planar, respectively. The first face 16 extends radially inward moving rearwardly relative to the rotational direction from the radially inner edge of the front face 20. The first face 16 has an inclination angle 16a with respect to a radial line L1 extending in the radial direction of the base metal 2. The inclination angle 16a may preferably be between 30° and 60°, for example 45°. A length of the first face 16 in the rotational direction may be, for example, 20% to 40% of the rotational length of the cutting tip 10, for example 0.5 mm.

As shown in FIG. 2, the second face 17 extends substantially orthogonally to the radial line L1 and substantially parallel to the circumferential line L2 rearwardly from the rear end of the first face 16 relative to the rotational direction. The second face 17 defines the radially innermost position of the thin portion 15. The thin portion 15 has a radial height 15b measured radially from the radially inner edge of the front face 20 to the second face 17. The radial height 15b is, for example, 10% to 30% of the height 10f of the tip body 10a. The height 15b may be, for example, 0.5 mm and corresponds to a radial distance from the radially inner area of the front face 20 to the second face 17.

Still shown in FIG. 2, the third face 18 extends radially outward moving from a rear end of the second face 17 relative to the rotational direction. The third face 18 has an inclination angle 18a with respect to the radial line L. The inclination angle 18a may be preferably between 30° and 60°, for example 45°. A length of the third face 18 measured in the rotational direction may be, for example, 10% to 30% of the length of the cutting tip 10, for example 0.3 mm, measured in the rotational direction. A rear end 18b of the third face 18 is located radially inward from the radially inner edge of the front face 20. The cutting tip 10 has a planar rear end face 19 extending radially outward from the radially outer edge of the third face 18 to the flank 13. The rear end face 19 extends substantially parallel to the radial line L1.

Still shown in FIG. 2, the tip-receiving seat 6 has a planar first face 6b, a second face 6c, a third face 6d, and a rear end 6e, which are formed in accordance with an external contours of the cutting tip 10. The cutting tip 10 is brazed, e.g. silver brazed to the first face 6b, the second face 6c, the third face 6d, and the rear end face 6e. The radially inner edge of the front face 20 of the cutting tip 10 is located at substantially the same position as a front end 6a of the tip-receiving seat 6 relative to the rotational direction.

As shown in FIG. 3, the thin portion 15 has radially extending side faces 21 on opposite sides in the thickness direction. A lower chamfer 14b is formed between a radially outer end of each side face 21 of the thin portion 15 and a radially inner end of the corresponding side face 14 of the tip body 10a. The lower chamfer 14b is inclined with respect to a central rotational axis of the circular saw blade 1 and may have a chamfer angle 14d of, for example, 45°. The lower chamfer 14b is planar and has a substantially uniform width in the rotational direction. The width of the lower chamfer 14b in the thickness direction may be, for example, 0.10 to 0.15 mm.

As described above, the circular saw blade 1 for metal cutting has a disk-shaped base metal 2, gullets 5 opening radially outward at the radially outer periphery of the base metal 2, and tip-receiving seats 6 recessed at rear ends of the gullets 5 relative to the rotational direction, as shown in FIGS. 2 and 3. The circular saw blade 1 has cutting tips 10 mounted to the base metal 2 within the tip-receiving seats 6 and projecting radially outward from the base metal 2. Each cutting tip 10 has a cutting edge 11 at the intersection of the rake face 12 and the flank 13. A blade thickness 10e of the cutting tip 10 is thicker than a thickness 2c of the base metal 2. The cutting tip 10 has a thin portion 15 on a radially inner side that is less than or equal to the thickness 2c of the base metal 2. The thin portion 15 is located within a thickness of the tip-receiving seat 6 in the thickness direction.

At the radially inner portions of the cutting tip 10, the Side faces 14 of the thin portion 15 are formed such that the side faces 14 do not protrude more in the thickness direction than the base metal 2. Therefore, the chips are prevented from colliding with a joint on a radially inner portion of the cutting tip 10, which may prevent chipping of the cutting tip 10. Further, clogging caused by chips may be prevented at the joint on the radially inner portion of the cutting tip 10. Thus, it is possible to prevent the cutting tip 10 from chipping due to the influence of the chips and to suppress cutting performance deterioration due to the clogging caused by the chips.

Still shown in FIG. 2, at the cutting edge 11, the rake angle 10c defined by the rake face 12 and the radial line L1 of the base metal 2 is negative. For example, the rake face 12 extends forward relative to the rotation direction moving radially inward from the cutting edge 11. The length in the rotational direction of the thin portion 15 at the radially inner side of the cutting tip 10 is greater than the length in the rotational direction of the radially outer side of the cutting tip 10. Therefore, an area of the joint at the radially inner side of the cutting tip 10 secured to the base metal 2 within the tip-receiving seat 6 is relatively large. This prevents the cutting tip 10 from being removed from the tip-receiving seat 6, thereby preventing a deterioration of the cutting performance.

As shown in FIGS. 2-3, the cutting tip 10 has a radially inner portion that is radially inward of the front end 6a of the tip-receiving seat 6. The thin portion 15 of the cutting tip 10 defines the entirety of such radially inner portion. Therefore, the protrusion of the cutting tip 10 in the thickness direction can be suppressed in the entire area of the joint of the thin portion 15 of the cutting tip 10, to which chips easily contact. As a result, chipping of the cutting tip 10 and clogging near the front end of the joint of the cutting tip 10 can be more reliably suppressed.

As shown in FIG. 2, the thin portion 15 has a first face 16 extending radially inward from the radially inner side of front face 20 moving rearwardly relative to the rotational direction. The thin portion 15 has a second face 17 extending rearwardly relative to the rotational direction from the first face 16. The thin portion 15 has a third face 18 extending radially outward from the rear end of the second face 17 moving rearwardly relative to the rotational direction. The cutting tip 10 has a rake face 12 on the front side relative to the rotational direction. An arc-shaped chip breaker 12a is recessed rearwardly relative to the rotational direction into the radially inner side of the rake face 12.

Referring still to FIG. 2, the thin portion 15 may have a convex shape extending radially inward as viewed in this thickness direction and as defined by the first face 16, the second face 17, and the third face 18. This geometry allows the cutting tip 10 to be firmly attached to the base metal 2 within the tip-receiving seat 6. Further, the displacement of the cutting tip 10 relative to the tip-receiving seat 6 in the rotational direction may be prevented. The radial length (height 10f) of the radially outer portion of the cutting tip 10 is relatively long to increase the radius of curvature of the chip breaker 12a. This prevents chips from forming distorted shapes in the chip breaker 12a and prevents chips from clogging in the chip breaker 12a. Therefore, a number of cutting tips 10 of the circular saw blade 1 can be increased, and the maximum number of working cutting tips 10 (the maximum number of cutting teeth 10 entering a groove formed in the workpiece at the time of cutting) can be increased more than those of conventional saw blade. Although the maximum number of working cutting tips has typically been 3.5 in conventional circular saw blades, in the circular saw blade 1 of the present disclosure, the maximum number of working cutting tips 10 could be increased to 5. Thus, for example, it is possible to cut solid material with the circular saw blade 1 having a diameter larger than that of solid material within the operating range of the conventional circular saw blade.

Various modifications may be made to the circular saw blade 1 of the present embodiment described above. The circular saw blade 1 has been illustrated in which the protrusions 4 are arranged at equally spaced pitches 4a in the circumferential direction of the base metal 2. Instead of this, the pitch 4a may be modified to unequal intervals. A configuration has been illustrated, in which two types of the cutting tips 10 (first tip 7 and second tip 8) with the groove 13a located at different left-right positions are used to cut grooves divided in the workpiece in the left-right directions. Alternatively, the circular saw blade 1 may have three or more types of the cutting tips 10 with the groove 13a located at different left-right positions. Instead of the U-shaped groove 13a, a V-shaped groove may be formed on the flank 13, for example.

The examples illustrated a configuration in which the thickness 2c of the base metal 2 and the thickness 15a of the thin portion 15 are the same, and the cutting tip 10 is mounted within the tip-receiving seat 6 such that the side face of the base metal 2 is flush with the side face 21 of the thin portion 15. Alternatively, the thickness 15a of the thin portion 15 may be thinner than the thickness 2c of the base metal 2. The center of the cutting tip 10 may be displaced to the left or to the right relative to the center in the thickness direction of the base metal 2, as long as the side face 21 of the thin portion 15 does not exceed the side face of the base metal 2 outwardly in the thickness direction. The ridge line where the front face 20 and the first face 16 of the cutting tip 10 intersect may be located radially outward from the front end 6a of the tip-receiving seat 6 relative to the rotational direction.

1. A circular saw blade for metal cutting, comprising:
a disk-shaped base metal having a central axis about which the circular saw blade is configured to rotate in a rotational direction to cut the metal;
a plurality of circumferentially-spaced gullets opening radially outward at an outer periphery of the base metal, wherein each gullet has a rear end relative to the rotational direction;
a plurality of circumferentially-spaced tip-receiving seats defined by a plurality of recesses in the base metal at the rear ends of the plurality of gullets; and
a plurality of cutting tips seated in the plurality of tip-receiving seats and mounted to the base metal, wherein the cutting tips protrude radially outward from the base metal,
wherein each cutting tip has a cutting edge at an intersection of a rake face and a flank of the cutting tip;
wherein the base metal has a thickness measured in a thickness direction of the base metal and each cutting tip has a thickness measured in the thickness direction that is greater than the thickness of the base metal;
wherein the each cutting tip has a thin portion on a radially inner side of the cutting tip, wherein the thin portion of each cutting tip has a thickness measured in a thickness direction that is equal to or less than the thickness of the base metal, and
wherein the thin portion of each cutting tip is positioned within one of the tip-receiving seats.

2. The circular saw blade according to claim 1, wherein a rake angle measured between the rake face and a radial line of the base metal is negative.

3. The circular saw blade according to claim 1, wherein the each of the cutting tips has an inner portion that is positioned radially inward of a front end of the corresponding tip-receiving seats relative to the rotational direction, and wherein the thin portion defines the entirety of the inner portion of the corresponding cutting tip.

4. The circular saw blade according to claim 1, wherein the thin portion of each cutting tip includes:
a first face extending radially inward from a front face of the corresponding cutting tip moving rearwardly relative to the rotational direction,
a second face extending rearwardly relative to the rotational direction from the first face, and
a third face extending radially outward from a rear end of the second face moving rearwardly relative to the rotational direction.

5. The circular saw blade according to claim 1, wherein the each cutting tip has a rake face on a front side relative to the rotational direction, and wherein an arc-shaped chip breaker is recessed into the rake face.

6. A circular saw blade for metal cutting, comprising:
a disk-shaped base metal having a circular mounting hole located at a center of the disk-shaped base metal for receiving a rotation shaft configured to rotate the circular saw blade in a rotational direction about a central axis to cut the metal;
a plurality of circumferentially-spaced gullets opening radially outward at an outer periphery of the base metal, wherein each gullet has a rear end relative to the rotational direction;
a plurality of circumferentially-spaced tip-receiving seats defined by a plurality of recesses in the base metal at the rear ends of the gullets;
a plurality of cutting tips seated in the plurality of tip-receiving seats and mounted to the base metal, wherein the cutting tips protrude radially outward from the base metal, and wherein each cutting tip includes:
a rectangular box-shaped tip body and a rectangular box-shaped thin portion extending radially inward from the rectangular box-shaped tip body,
wherein the rectangular-box shaped tip body has a cutting edge at an intersection of a rake face on a front side of the rectangular-box shaped tip body relative to the rotational direction and a flank on a radially outer side of the rectangular-box shaped tip body, wherein the cutting edge extends in a thickness direction of the base metal, and
wherein a circumferentially extending groove is formed in the flank.

7. The circular saw blade according to claim 6, wherein the groove extends circumferentially from the cutting edge to a rear end of the flank.

8. The circular saw blade according to claim 6, wherein the groove is U-shaped or V-shaped as viewed in the rotational direction.

9. The circular saw blade according to claim 6, wherein each groove is located off-centered to a left or right from a center of the corresponding cutting tip in the thickness direction by a predetermined distance.

10. The circular saw blade according to claim 6, wherein the plurality of cutting tips include a plurality of first cutting tips and a plurality of second cutting tips, wherein each of the first cutting tips has the groove located off-centered to a left from a center of the corresponding first cutting tip in the thickness direction as viewed in the rotational direction, and wherein each of the second cutting tips has the groove located off-centered to a right from a center of the corresponding second cutting tips in the thickness direction as viewed in the rotational direction.

11. The circular saw blade according to claim 10, wherein the first cutting tips and the second cutting tips are arranged in a circumferentially alternating manner.

12. A circular saw blade for metal cutting, comprising:
a disk-shaped base metal having a circular mounting hole located at a center of the disk-shaped base metal for receiving a rotation shaft configured to rotate the circular saw blade in a rotational direction about a central axis to cut the metal;
a plurality of circumferentially-spaced gullets opening radially outward at an outer periphery of the base metal, wherein each gullet has a rear end relative to the rotational direction;
a plurality of circumferentially-spaced tip-receiving seats defined by a plurality of recesses at the rear ends of the gullets;
a plurality of cutting tips seated in the plurality of tip-receiving seats mounted to the base metal, wherein the cutting tips protrude radially outward from the base metal, wherein each of the plurality of cutting tips includes:
a rectangular box-shaped tip body and a rectangular box-shaped thin portion extending radially inward from the rectangular box-shaped tip body,
wherein the rectangular-box shaped tip body has a cutting edge at an intersection of a rake face on a front side of the rectangular-box shaped tip body relative to the rotational direction and a flank on a radially outer side of the rectangular-box shaped tip body, wherein the cutting edge extends in a thickness direction of the base metal,
wherein a circumferentially extending groove is formed in the flank, and
wherein a chip breaker is formed along the rake face and extends across an entirety of the rectangular-box shaped tip body in the thickness direction.

13. The circular saw blade according to claim 12, wherein the chip breaker is arc-shaped for curling chips in a spring-like shape.

14. The circular saw blade according to claim 13, wherein the spring-like shaped chips are configured to be discharged from the plurality of gullets by elastic force.

15. The circular saw blade according to claim 12, wherein the rectangular box-shaped tip body has a front face extending radially inward from a radially inner side of the chip breaker to the base metal.

16. The circular saw blade according to claim 12, wherein the rectangular box-shaped tip body has a first side face and a second side face spaced apart from the first side face in the thickness direction.

17. The circular saw blade according to claim 16, wherein each side face of the rectangular box-shaped tip body is inclined relative to a radial direction of the base metal by an angle ranging from 0 to 2 degrees.

18. The circular saw blade according to claim 12, further comprising an upper chamfer formed between the flank and a side face of the rectangular-box shaped tip body, wherein the upper chamfer is inclined with respect to the flank.

19. The circular saw blade according to claim 18, wherein the upper chamfer is defined by a planar surface having a uniform width in the thickness direction moving from a front of the flank relative to the rotational direction to a rear of the flank relative to the rotational direction.

20. The circular saw blade according to claim 19, wherein the width of the upper chamfer in the thickness direction ranges from about from 0.05 mm to 0.1 mm.
